(19) United States
(12) Patent Application Publication
(10) Pub. No.: US 2021/0346853 A1
(43) Pub. Date: Nov. 11, 2021

(54) SYSTEMS AND METHODS OF PRODUCING STABLE HOMOGENOUS DISPERSIONS OF IMMISCIBLE FLUIDS

(71) Applicant: Kerry Luxembourg S.à.r.l., Luxembourg (LU)

(72) Inventors: Richard HULL, Athens, GA (US); Bilal KIRMACI, Springfield, MO (US); Mo Mui TOLEDO, Hull, GA (US); Romeo TOLEDO, Hull, GA (US)

(73) Assignee: Kerry Luxembourg S.à.r.l., Luxembourg (LU)

(21) Appl. No.: 17/274,712

(22) PCT Filed: Sep. 9, 2019
(86) PCT No.: PCT/IB2019/057585

§ 371 Date: Mar. 9, 2021

Related U.S. Application Data
(60) Provisional application No. 62/728,949, filed on Sep. 10, 2018.

(51) Int. Cl. B01F 3/08

(52) U.S. Cl. CPC B01F 3/0811; B01F 2003/0849; B01F 2003/0834; B01F 3/0853

(57) ABSTRACT

Embodiments of the present invention provide systems and methods of producing stable homogeneous dispersions of non-polar fluid(s) in a continuous phase of polar fluid(s) or of polar a continuous phase of non-polar fluid(s) without using synthetic emulsifiers and/or other chemical surfactants.

### CROSS-REFERENCE TO RELATED APPLICATIONS

This application claims the benefit of U.S. Provisional Application No. 62/728,949, filed Sep. 10, 2018, which is incorporated by reference herein in its entirety.

### BACKGROUND

Molecules of compounds containing covalent bonds pray be non-polar or polar depending, for example, on relative molecular electronegativity, stereochemistry, and orientation of their polar moieties. Non-polar molecules (including, but not limited to, essential oils, oleoresins, fragrances, and extracts) are not miscible with water and when mixed these components separate into t :o phases upon storage.

### SUMMARY

Various embodiments of the present invention provide improved stability or holding time of homogeneous dispersions of immiscible fluids. A dispersion according to some embodiments of the invention may be produced, for example, by passing mixture of immiscible fluids through a continuous-flow system that subjects the mixture to high shear combined with cavitation to overcome individual fluid surface tensions and physically produce nano-sized droplets (e.g., having a diameter of about 10⁻⁸ to about 10⁻⁹ meters) of dispersed fluid in a continuous phase of dispersion medium. These droplets do not immediately coalesce on standing, and can remain dispersed for prolonged periods of time.

In some embodiments, the invention provides a method of producing a stable homogenous dispersion of immiscible fluids without dding an emulsifier, comprising providing a macroemulsion containing the immiscible fluids and no added emulsifier, and passing said macroemulsion through a processor configured for turbulent fluid flow, thereby producing a microemulsion comprising a plurality of droplets of dispersed fluid in a continuous phase of dispersion medium, which droplets do not separate from the dispersion medium during storage at room temperature, wherein the processor comprises a housing having an inlet and an outlet; and a processing element extending axially through the housing, the processing element comprising a plurality of discs, each disc having one or more apertures formed therein and together located to one side of the disc, the apertures of adjacent discs radially opposed to each other,

In some embodiments, the dispersed fluid is a non-polar fluid and the dispersion medium is a polar fluid medium.

In some embodiments, the macroemulsion comprises water processed through the processor.

In some embodiments, the macroemulsion is pre-mixed using a high-speed propeller-type mixer before passing through the processor.

In some embodiments each disc is formed with three apertures.

In some embodiments, the discs are spaced a predetermined distance apart from each other.

In some embodiments, the cross-sectional area of the apertures in each disc is substantially the same as the cross-sectional area of the inlet and outlet, and the cross-sectional area between adjacent discs is greater than the cross-sectional area of the inlet and outlet.

In some embodiments, the discs are formed from an alloy of metals of differing electronegativity.

In some embodiments, the alloy comprises at least one metal selected from a first group and at least one metal selected from second group, wherein the electronegativity of the second group is substantially opposite to that of the first group.

In some embodiments, the first group comprises titanium, molybdenum, silver, silicon, copper, and nickel, and the second group comprises tin, chromium, manganese, and cadmium.

Additional features and advantages of embodiments of the present invention are described further below. This summary section is meant merely to illustrate certain features, and is not meant to limit the scope of the invention in any way. The failure to discuss a specific feature or embodiment of the invention, or the inclusion of one or more features in this summary section, should not be construed to limit the invention as claimed.

### BRIEF DESCRIPTION OF THE DRAWINGS

The foregoing summary, as well as the following detailed description of certain embodiments, will be better understood when read in conjunction with the appended drawings. It should be understood, however, that the invention is not limited to the precise arrangements and instrumentalities shown. In the drawings:

FIG. 1 shows a cross-sectional side view of one example of a processor that may be used to produce dispersions according to some embodiments of the invention;

FIG. 2 shows a cross-sectional end view of the example of FIG. 1 along line 2-2; and

FIG. 3 shows a schematic of a system used to process immiscible fluids according to some embodiments of the invention.

### DETAILED DESCRIPTION

The use of non-polar food ingredients, such as flavors, colors, textural modifiers, or spoilage inhibitors presents a problem of non-uniform dispersion resulting in physical separation during storage or ineffective delivery of the intended functional attributes. The normal method for producing homogeneity in mixtures of polar and non-polar fluids is the use of emulsifiers and subjecting the three-component mixture to intense mixing or continuous flow through a narrow channel in a process known as homogenization. Emulsifiers are compounds that have both polar and non-polar moieties in the molecule therefore they can function as a bridge between the non-polar moieties of the molecules of the dispersed phase and the polar moieties of the dispersion medium molecules. Emulsion stability and length of holding time before separation of the dispersed phase and the dispersion medium depends on the concentration of the emulsifier, the interaction of the polar and non-polar moieties of molecules of the two immiscible fluids and the emulsifier, size of the droplets of the dispersed phase, viscosity of the mixture, and temperature.

Non-polar food ingredients, commonly referred to as oil-soluble ingredients, are widely used in the food industry. Since most foods have water as their primary component, the effective use of these oil-soluble ingredients depends on uniform dispersion of components to form a homogeneous mixture. In meat and poultry, oil-soluble ingredients are added for flavor and/or color through a marinade or by direct addition such as in comminuted processed meats. Oil-soluble antimicrobials may also be sprayed on whole muscle to control pathogens and extend shelf-life. A major problem in uniformly dispersing these oil-soluble ingredients in whole muscle is that whole meat, particularly ports and beef, usually contain layers of fat and lean. When sprayed, the emulsion comprising water and water-soluble ingredients and oil-soluble flavor, color, and antimicrobial ingredients must be in a diluted form at the time of application to ensure adequate flow of atomized liquid at adequate velocity upon impingement on the meat surface. In most emulsions, coalescence of the oil-soluble droplets will occur they will separate from the aqueous phase resulting in non-uniform liquid spray impinging on the meat surface between those meats leading entry into the spray chamber and those entering later. Thus, it is important that mixtures comprising oil-soluble and water-soluble ingredients and water are uniformly dispersed and homogeneous. If the emulsified ingredients are made in a remote location from the point of use, and if the mixture is not used immediately after preparation, stability of the emulsion becomes an important property for the mixed ingredient to be consistently effective.

Particle size of the dispersed phase in a mixture of immiscible fluids is around 1 mm for macroemulsions and 1 nm to 1 μm for microemulsions. The larger the sire of the dispersed phase droplets, the higher the emulsifier concentration needed to maintain homogeneity and the greater the tendency towards coalescence. However, the power requirement t.o reduce the droplet size increases with decreasing droplet size. Thus, it is often necessary to optimize the emulsifier concentration and the intensity homogenization parameters to obtain stable homogeneous dispersions.

Homogenizers are well known in the food industry and have been in use for over 100 years. However, the basic principlef the homogenization process has remained the same. First, the mixture of dispersed phase, dispersion medium, and emulsifier is thoroughly mixed outside the homogenizer. This well-mixed liquid is pumped at high pressure through a narrow channel to increase the velocity followed by impingement, of the high velocity fluid against a plate to reduce the velocity and divert the flow through narrower channels. Finally the homogenized fluid exits the homogenizer at ambient pressure. A major problem with homogenizers is coalescence of the droplets of the dispersed phase as they leave the continuous flow channels of the homogenizer. Thus, the droplet size is distributed over a range of sizes and although multi-stage homogenizers and/or multiple passes through the homogenizer may be used, this approach only shifts the predominant droplet size to the smaller values while a number of droplets in the large sizes may still be present. These large droplets would have a strong tendency to coalesce and separate from the bulk of the liquid emulsion. To maintain a stable homogeneous dispersion, even with the predominance of very small droplet sizes, emulsifiers would still be needed if there are enough large sized droplets present.

The trend towards consumer-friendly label statements in food products is strongly influencing the formulation of products that eliminate the need for chemical sounding names. Typically, effective emulsifiers for oil-in-water dispersions are synthetic compounds with chemical sounding names. Elimination of synthetic emulsifiers from the label not only results in a consumer-friendly label but also a label with reduced number of married ingredients. Embodiments of the present invention provide an emulsification process that permits the production of stable homogeneous oil-in-water dispersions without the addition of emulsifiers and/or other chemical surfactants. However, some embodiments of the invention may macroemulsions containing natural emulsifiers.

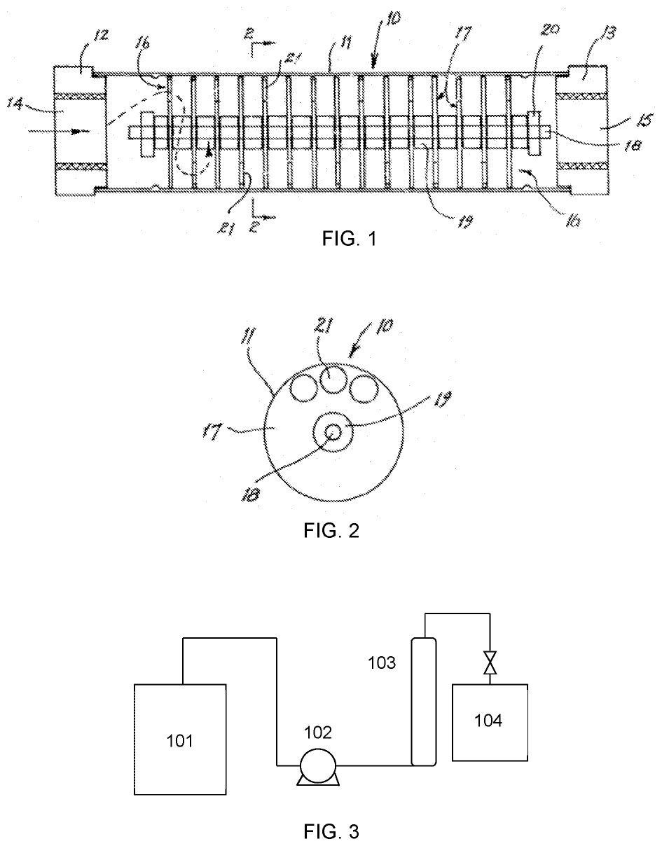

Some embodiments of the invention provide methods of producing minute droplets of a non-polar fluid dispersed in a polar fluid medium without the need for adding an emulsifier or surfactant. This is achieved using a processor that comprises a stack of discs (round or other shape) installed within a pipe with gaps between the discs. The discs function as turbulence promoters and create high shear, turbulence, and cavitation in a fluid flowing through the pipe in which the promoters are installed. An example of a processor suitable for use in these methods is the water conditioner disclosed in Australian Patent No. 580474, which is incorporated by reference herein in its entirety. FIGS. 1 and 2 show this water conditioner 10 with tubular housing 1, threaded bosses 12 and 13 at inlet 14 and outlet 15, respectively, and conditioning element 16 comprising a plurality of discs 17 with apertures 21 on a rod 18 with spacers 19 therebetween and nuts or other clamping means 20 at each end. Housing 11 may be formed of copper, bosses 12 and 13 of brass, rod 18 of stainless steel, and discs 17 and spacers 19 of an alloy containing titanium, molybdenum, silver, silicon, copper, nickel, iron, zinc, tin, chromium, manganese, and cadmium. An example of this water conditioner is available commercially as the SofterWater Conditioner cc from Turbu-Flow Pty Ltd, which prevents scale from forming by neutralizing the scale producing properties of the minerals in hard water (see, e.g., the website at softerwater.com.au).

The present invention is the first reported use of such a processor in promoting the dispersion of a non-polar fluid in water. It was recognized by the present inventors that in a pair of the turbulence promoter discs within the processor, induction of turbulence in the flow fluid and the reversing circumferential flow direction as fluid traverses from one disc to the has an effect similar to that in one valve of a homogenizer. Thus, the stack of discs within the processor treats the fluid similar multiple passes through a standard homogenizer valve. The continuous multiple-pass homogenizing effect provided by the processor has been found to eliminate the coalescence of dispersed phase droplets between multiple passes through a single homogenizer valve, thereby producing microemulsions with dispersed phase droplets distributed within a narrow range of particle sizes. Without wishing to be bound by theory, it is believed that in the microemulsions produced using the processor, the dispersed phase droplets may be surrounded by molecules of the dispersion medium so that they are prevented from precipitating, thereby maintaining a stable homogeneous dispersion.

To be effective in producing stable homogeneous dispersion the dispersed phase is preferably mixed thoroughly within the dispersion medium before passing the mixture through the processor. This can be achieved, for example, using a standard laboratory mixer and observing that the fluid to be dispersed no longer forms a film of fluid separate from dispersion medium. Thus, the dispersed phase is preferably a fluid before it is mixed. Most oil-soluble resinous materials are usually available dissolved in a food-grade solvent and such a solution would be suitable for use in the embodiments described herein

In other embodiments, the invention provides methods of producing a concentrated dispersion of an oil-soluble liquid suitable for dilution at the point of use to the required effective concentration of the functional ingredient. It has been observed by the present inventors that when the dispersion medium used as the diluent is passed through the processor at the point of dilution, there was no separation of the phases for a prolonged period.

### EXAMPLE

An example of a process for producing a dispersion of a non-polar ingredient uniformly dispersed fluid in a polar dispersion medium is an emulsion of resinous material from hops in water. The resinous material from the hop plant (Humulus lupulus) is commonly referred to as hop acids and consists of a complex hexagonal molecule with long side chains containing ketone and alcohol moieties. The mixture of compounds in this resinous material has been shown to be a suitable replacement for antibiotics in animal feed (see, e.g., U.S. Pat. No. 7,090,873, incorporated herein by reference). The resin may be obtained commercially as a resinous paste.

High shear, turbulence, and cavitation, created by a processor on a skid (FIG. 3), were used to disperse resinous hop acids product in water. Two different water types were compared against a control treatment. A processing system according to certain illustrative embodiments of the present invention is shown in FIG. 3, and includes a reservoir 101, a pump 102, a processor 103, and a collection tank 104. In this Example, processor 103 was a multi-disc turbulence promoter obtained from Turbu-Flow Pty Ltd (as described above and depicted in FIGS. 1 and 2); however, in other embodiments other processors with a plurality of discs or other functionally-equivalent turbulence promoter structures therein may be used.

Test 1 was a dispersion containing 1% hop acids in untreated tap water with 0.5% propylene glycol and the macroemulsion was made using a high-speed propeller-type mixer.

Test 2 utilized tap water processed through processor 103 as the dispersion medium. A 1% hop acids dispersion was made with 0.5% propylene glycol and the macroemulsion was made using a high-speed propeller-type mixer.

Test 3 also utilized tap water processed through processor 103 as the dispersion medium. A 1% hop acids dispersion was made without additives, pre-mixed using a high-speed propeller-type mixer, and the macroemulsion was processed again through processor 103. It is hypothesized that the processed water permitted molecular water to coat the dispersed droplets after they were formed upon passage of the macroemulsion through processor 103, thus preventing coalescence and stabilizing the microemulsion,

The parameters used for processing Test 1, Test 2, and Test 3 are shown in Table 1, which details the physical conditions of initial and final processing.

TABLE 1

| | Initial water processing | | | | | Final processing* | | |
|---|---|---|---|---|---|---|---|---|
| | Temperature | | | | | Temperature | | |
| | ° F. | | Pressure | Flow rate | Pre-Mix | ° F. | | Pressure |
| Treatment | In | Out | psi | gal/min | Temperature ° F. | In | Out | psi |
| Test 1 | n/a | n/a | n/a | n/a | 82.0 | n/a | n/a | n/a |
| Test 2 | 82.0 | 82.4 | 50 | 4.67 | 82.0 | n/a | n/a | n/a |
| Test 3 | 81.3 | 82.7 | 56 | 4.67 | 82.0 | 79.8 | 89.0 | 50 |

*Flow rate of final processing was 4.6 gal/min for Test 3

Table 2 shows observations on hop acids solutions produced in Test 1, Test 2, and Test 3 (observations on 1% hop acids solutions during storage). Test 1, with propylene glycol and tap water was not stable and separated over time. Multiple types of precipitation (brown, white residues) were clearly visible on the bottom and stuck to the sides of the vessel. Test 2, also with propylene glycol and water pretreated through processor 103 yielded a stable emulsion initially, however the hop acids component precipitated within a week. Test 3, without additives, made with water pretreated through processor 103 then reprocessed through the same processor after addition of the hop acids, yielded a stable homogenous dispersion. After six months of storage at room temperature. Test 3 remained stable and showed no signs of separation.

TABLE 2

| Treatment | Observations |
|---|---|
| Test 1 | Begins to separate after mixing. |
| | Multiple types of precipitate and |
| | sludge (brown and white) on the |
| | bottom of container. |
| | Sticky sludge on the sides. |
| Test 2 | Stable immediately after mixing. |
| | Loss of stability observed after |
| | 2-3 days storage as evidenced by |
| | precipitate and sludge similar to |
| | that observed in Test 1. |
| Test 3 | Stable homogenous dispersion. |

These results show that processors that can produce dispersed phase droplets in the nanometer size range can be effective in producing stable homogeneous dispersions of emulsifier-free immiscible liquids.

Methods according to illustrative embodiments of the present invention have been demonstrated using a Turbu-Flow processor, but other devices capable of producing nano-sized dispersed phase droplets may also be utilized, such as, but not limited to, the nanobubble generator described in US 2016/0236158 assigned to EBED HOLDINGS, INC. (Baden, Ontario, Canada) and the micro-nano bubble generator (ASCH/ASG2) from ASUPU CO LTD (Shizuoka, Japan; see, e.g., the operating manual for ASG1 available online at www.manualslib.com/manual/10251.20/Asupu-Asg1.html).

Further, although the example provided herein uses hop acids and water, other applications may use other normally-immiscible fluids, such as, but not limited to, solutions including cannabidiol (CBD) or other phytocarmabinoids.

While there have been shown and described fundamental novel features of the invention as applied to the preferred and exemplary embodiments thereof, it will be understood that omissions and substitutions and changes in the form and details of the disclosed invention may be made by those skilled in the art without departing from the spirit of the invention, Moreover, as is readily apparent, numerous modifications and changes may readily occur to those skilled in the art. For example, any feature(s) in one or more embodiments may be applicable and combined with one or more other embodiments. Hence, it is not desired to limit the invention to the exact construction and operation shown and described and, accordingly, all suitable modification equivalents may be resorted to falling within the scope of the invention as claimed. It is the intention, therefore, to be limited only as indicated by the scope of the claims appended hereto.

What is claimed is:

1. A method of producing a stable homogenous dispersion of immiscible fluids without adding an emulsifer, comprising providing a macroemulsion containing immiscible fluids and no added emulsifier; and passing said macroemulsion through a processor configured for turbulent fluid flow, thereby producing a microemulsion comprising a plurality of droplets of dispersed fluid in a continuous phase of dispersion medium, which droplets do not separate from the dispersion medium during storage at room temperature, wherein the processor comprises a housing having an inlet and an outlet; and a processing element extending axially through the housing, the processing element comprising a plurality of discs, each disc having one or more apertures formed therein and together located to one side of the disc, the apertures of adjacent discs radially opposed to each other.

2. The method of claim 1, wherein the dispersed fluid is a non-polar fluid and the dispersion medium is a polar fluid medium.

3. The method of claim 1, wherein the macroemulsion comprises water processed through the processor.

4. The method of claim 1, wherein the macroemulsion is pre-mixed using a high-speed propel type mixer before passing through the processor.

5. The method of claim 1, wherein each disc is formed with three apertures.

6. The method of claim 1, wherein the discs are spaced a predetermined distance apart from each other.

7. The method of claim 1, wherein the cross-sectional area of the apertures in each disc is substantially the same as the cross-sectional area of the inlet and outlet., and the cross-sectional area between adjacent discs is greater than the cross-sectional area of the inlet and outlet.

8. The method of claim 1, wherein the discs are formed from an alloy of metals of differing electronegativity.

9. The method of claim 8, wherein the alloy comprises at least one metal selected from a first group and at least one metal selected from a second group, wherein the electronegativity of the second group is substantially opposite to that of the first group.

10. The method of claim 9, wherein the first group comprises titanium, molybdenum, silver, silicon, copper, and nickel, and the second group comprises tin, chromium, manganese, and cadmium.
